(19) United States
(12) Patent Application Publication
(10) Pub. No.: US 2021/0027260 A1
(43) Pub. Date: Jan. 28, 2021

(54) A SYSTEM FOR PROVIDING AN END-TO-END NETWORK

(71) Applicant: Zeetta Networks Limited, Bristol (GB)

(72) Inventors: Crispin DENT-YOUNG, Bristol (GB); Nathan SOWATSKEY, Bristol (GB); Vassilis SEFERIDIS, Bristol (GB); Catherine Ellen Anne MULLIGAN, Bristol (GB)

(73) Assignee: Zeetta Networks Limited, Bristol (GB)

(21) Appl. No.: 16/766,570

(22) PCT Filed: Nov. 21, 2018
(86) PCT No.: PCT/GB2018/053366

§ 371 Date: May 22, 2020

(30) Foreign Application Priority Data
Nov. 24, 2017 (GB) 1719556.1

(51) Int. Cl. G06Q 20/02; G06Q 30/00; H04L 12/715; H04L 29/06; H04L 9/32

(52) U.S. Cl. CPC G06Q 20/027; G06Q 30/018; H04L 45/64; H04L 2209/56; H04L 9/3236; G06Q 2220/00; H04L 2209/38; H04L 63/0823

(57) ABSTRACT

The present invention relates to the application of Distributed Ledger Technology (DLT) to the field of software defined networking in a system and method for providing an end-to-end network comprising a plurality of software defined networks (SDNs) wherein each of the plurality of software defined networks is controlled by a software defined network controller (SDNC), the system comprising: a distributed ledger, wherein the distributed ledger is associated with a Smart Contract, wherein the Smart Contract comprises software code configured to control access by SDNCs to the distributed ledger by assessing whether a business entity and an SDNC operated by the business entity, requesting access to the distributed ledger, meet predefined trust criteria.

### TECHNICAL FIELD

The present application relates to the application of Distributed Ledger Technology (DLT) in the field of software defined networking (SDN), and in particular to a DLT system and method for providing an end-to-end network comprising a plurality of software defined networks, each of which is controlled by a software defined network controller (SDNC).

### BACKGROUND TO THE INVENTION

Software Defined Networking (SDN) has become increasingly relevant within the field of computer networking, as a means by which service providers can dynamically deliver connectivity and associated services at lower cost and with greater flexibility than would otherwise be possible. A core component of such systems is the SDN Controller (SDNC). SDNCs are often referred to as the ‘brains’ of an SDN network because they act as a centralised “strategic” control point in the SDN network. As shown in FIG. 1, SDNCs manage flow control, configuration, provisioning and monitoring of services in switches and/or routers of the network via Southbound Application Programming Interfaces (APIs), in response to direction from applications and business logic delivered via Northbound APIs, to deploy so-called “intelligent networks” as shown in FIG. 2. An intelligent network can include multiple different physical switches and routers configured by the SDNC to implement the intelligent networks. Additionally, an intelligent network can be made up of virtual networks and network slices implemented by physical compute resources, switches and routers.

In large and/or complex networks (e.g. telecommunications networks extending across different countries) a single SDNC typically controls only a specific network domain, and so several SDNCs need to coordinate their activities in order to provide a service across multiple networks (so called “end-to-end” service) as shown in FIG. 3.

Provisioning end-to-end services across multiple networks controlled by multiple independent SDNCs in a secure manner gives rise to a number of technical challenges, as set out below:

1. How one SDNC can locate another SDNC that controls a network that could be used in the context of provisioning an end-to-end service across multiple networks;

2. How virtual networks or network slices can be dynamically created on the fly, with the appropriate properties for the end-to-end service, when required;

3. How SDNCs involved in multi-network service provisioning can establish trust relationships such that they can interact with each other;

4. How such interactions can be recorded for the purposes of billing, audit, service level agreement (SLA) monitoring and similar business transactions; and

5. How such business transactions can be automatically facilitated for the exchange of financial value.

The outcome of addressing these five points is to create the capability for multiple independent SDNCs to act together as a logically single, but actually distributed, SDNC for the purposes of managing and monitoring services provisioned across multiple independent networks, on demand.

Current mechanisms to address these challenges are based on out-of-band, manual interactions between service providers. For example, service providers will form business relationships, sign contracts and exchange certificates and SDNC IP addresses and/or host names. After such manual exchanges, SDNCs are manually configured to know about and trust each other. Such mechanisms inherently cannot support a system within which SDNCs and the networks they control are dynamically instantiated upon demand.

Thus, a need exists for a solution that addresses the challenges discussed above without requiring manual exchanges. Without a solution of this nature, the SDN/network function virtualisation (NFV) vision will not be realised or will be hugely more expensive than currently recognised. Specifically, dynamically provisioned SDNCs, managing potentially dynamically provisioned networks, will not be able to discover and form trust relationships with appropriate other SDNCs to facilitate the creation of a resilient, distributed, logical SDNC for end-to-end service provisioning over the networks from the multiple domains supported by the SDNCs. Nor, therefore, will the dynamic forms of business relationships supported by such a distributed logical SDNC be possible.

### SUMMARY OF INVENTION

According to a first aspect of the present invention there is provided a system for providing an end-to-end network comprising a plurality of software defined networks (SDNs), wherein each of the plurality of software defined networks is controlled by a software defined network controller (SDNC), the system comprising: a distributed ledger, wherein the distributed ledger is associated with a Smart Contract, wherein the Smart Contract comprises software code configured to control access by SDNCs to the distributed ledger by assessing whether a business entity and an SDNC operated by the business entity, requesting access to the distributed ledger, meet predefined trust criteria.

The distributed ledger may be further configured to permit SDNCs meeting the predefined trust criteria to advertise themselves to other SDNCs meeting the predefined trust criteria.

The distributed ledger may be searchable by an SDNC seeking access to a network with particular requirements.

The distributed ledger may be configured to record networks and capabilities advertised by SDNCs participating in the distributed ledger.

The distributed ledger may be configured to record the results of a search of the distributed ledger performed by an SDNC seeking access to a network with particular requirements.

The distributed ledger may be configured to record interactions between business entities operating SDNCs, and interactions between SDNCs, participating in the distributed ledger.

The smart contract may be configured to record, in the distributed ledger, a request from a first SDNC participating in the distributed ledger sending a message to or making a request of a second SDNC participating in the distributed ledger.

The second SDNC may be configured to check that the request is present in the distributed ledger before it acts on the request.

The distributed ledger may be configured to record exchanges of value between business entities operating SDNCs participating in the distributed ledger.

The distributed ledger may be further configured to provide a certificate issuing mechanism for issuing certificates for SDNCs, wherein a certificate identifying an SDNC indicates that the SDNC can be trusted by other SDNCs participating in the distributed ledger.

The Smart Contract may be configured to verify the validity of the business entity (BE) operating the SDNC requesting access to the distributed network by checking one or more of: validity of a bank account of the BE; legal status of the BE; past financial history of the BE; and physical location of the BE.

The Smart Contract may be configured to verify the existence or properties of networks advertised by an SDNC as being controlled or controllable by that SDNC.

The Smart Contract may be configured to ensure that properties of an end-to-end service provisioned across a plurality of different networks are maintained in accordance with a service level agreement for the service.

The properties may include one or more of: quality of service; location; bandwidth; latency; jitter; and temporal availability.

The Smart Contract may be configured to manage exchanges of value between business entities operating SDNCs participating in the distributed ledger on establishment, use, or tear down of a service or periodically.

The Smart Contract may be configured to determine a reputation of a BE that operates an SDNC participating in the distributed ledger based on interactions between the SDNC and other SDNCs participating in the distributed ledger over time.

The Smart Contract may be configured to impose restrictions on the operations of a SDNC participating in the distributed ledger in the event that the SDNC or a BE that owns the SDNC fails to meet predefined criteria.

The predetermined criteria may include the reputation of the BE, as determined by the Smart Contract.

According to a second aspect of the invention there is provided a method for providing an end-to-end network comprising a plurality of software defined networks (SDNs), wherein each of the plurality of software defined networks is controlled by a software defined network controller (SDNC), the method comprising: providing a distributed ledger, wherein the distributed ledger is associated with a Smart Contract, wherein the Smart Contract comprises software code configured to control access by SDNCs to the distributed ledger by assessing whether a business entity and an SDNC operated by the business entity, requesting access to the distributed ledger, meet predefined trust criteria.

The distributed ledger may be further configured to permit SDNCs meeting the predefined trust criteria to advertise themselves to other SDNCs meeting the predefined trust criteria.

The distributed ledger may be searchable by an SDNC seeking access to a network with particular requirements.

The distributed ledger may record networks and capabilities advertised by SDNCs participating in the distributed ledger.

The distributed ledger may record the results of a search of the distributed ledger performed by an SDNC seeking access to a network with particular requirements.

The distributed ledger may record interactions between business entities operating SDNCs, and interactions between SDNCs, participating in the distributed ledger.

The smart contract may record, in the distributed ledger, a request from a first SDNC participating in the distributed ledger sending a message to or making a request of a second SDNC participating in the distributed ledger.

The second SDNC may check that the request is present in the distributed ledger before it acts on the request.

The distributed ledger may record exchanges of value between business entities operating SDNCs participating in the distributed ledger.

The distributed ledger may be further configured to provide a certificate issuing mechanism for issuing certificates for SDNCs, wherein a certificate identifying an SDNC indicates that the SDNC can be trusted by other SDNCs participating in the distributed ledger.

The Smart Contract may verify the validity of the business entity (BE) operating the SDNC requesting access to the distributed network by checking one or more of: validity of a bank account of the BE; legal status of the BE; past financial history of the BE; and physical location of the BE.

The Smart Contract may verify the existence or properties of networks advertised by an SDNC as being controlled or controllable by that SDNC.

The Smart Contract may be configured to ensure that properties of an end-to-end service provisioned across a plurality of different networks are maintained in accordance with a service level agreement for the service.

The properties may include one or more of: quality of service; location; bandwidth; latency; jitter; and temporal availability.

The Smart Contract may manage exchanges of value between business entities operating SDNCs participating in the distributed ledger on establishment, use, or tear down of a service or periodically.

The Smart Contract may determine a reputation of a BE that owns an SDNC participating in the distributed ledger based on interactions between the SDNC and other SDNCs participating in the distributed ledger over time.

The Smart Contract may be configured to impose restrictions on the operations of a SDNC participating in the distributed ledger in the event that the SDNC or a BE that owns the SDNC fails to meet predefined criteria.

The predetermined criteria may include the reputation of the BE, as determined by the Smart Contract.

### BRIEF DESCRIPTION OF THE DRAWINGS

Embodiments of the invention will now be described, strictly by way of example only, with reference to the accompanying drawings, of which:

FIG. 1 is a schematic diagram illustrating the use of an SDN controller for management of flow control and configuration, provisioning and monitoring of services in an SDN;

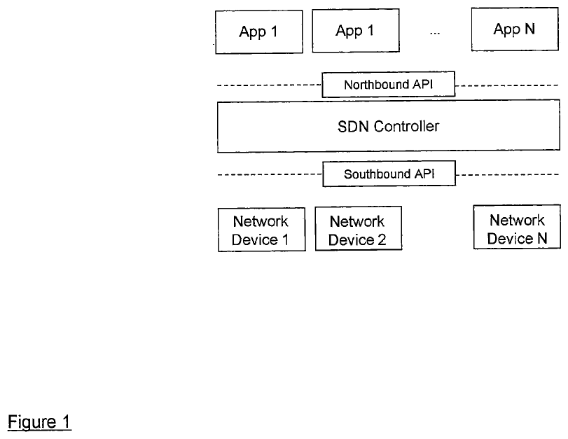

FIG. 2 is a schematic conceptual representation of a software defined network (SDN);

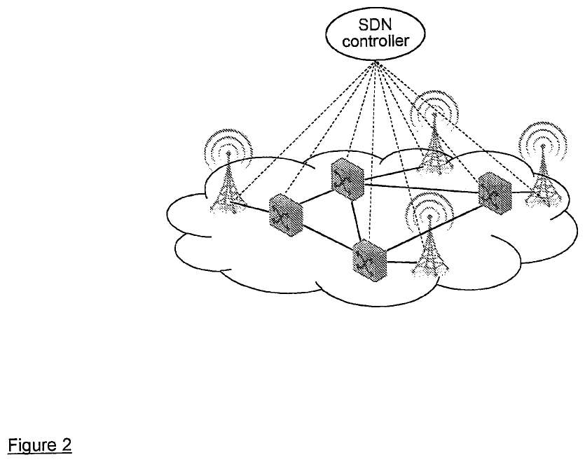

FIG. 3 is a schematic conceptual representation of a multi-domain network which uses multiple software defined network controllers (SDNCs);

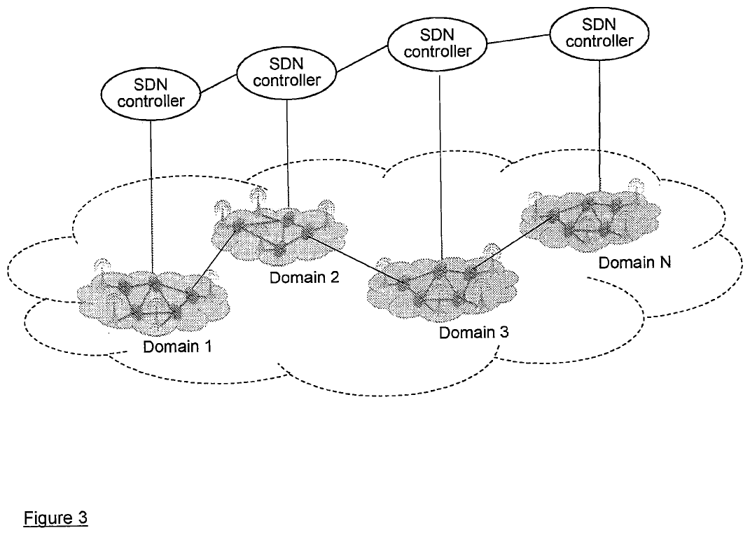

FIG. 4 is a schematic conceptual representation of a circle of trust supported by an SDN distributed ledger;

FIG. 5 is a flow diagram illustrating steps performed in a process for registering a new SDNC into a circle of trust;

FIG. 6 is a flow diagram illustrating steps performed in a process for start-up of an SDNC or re-admitting an SDNC into a circle of trust; and

FIG. 7 is a flow diagram illustrating steps performed in a process for service establishment in a circle of trust.

### DESCRIPTION OF THE EMBODIMENTS

The first requirement for provisioning services across a plurality of networks each controlled by an independent SDNC in a secure manner, thus effectively creating a single end-to-end network, is for the SDNCs that control the plurality of networks to coordinate with one another to provision the services across different domains, both within a given service provider's networks, and across networks from different service providers.

As outlined above, one technical challenge that arises in provisioning services in this manner is how one SDNC can identify which other SDNCs control networks that could be part of the single end-to-end network.

The techniques discussed herein address this challenge by providing means for SDNCs to advertise themselves in a distributed ledger, such that the distributed ledger can be searched by other SDNCs that require a network that satisfies specific requirements of the end-to-end service that needs to be provisioned. A distributed ledger is used so that a record of the networks, properties and capabilities that a given SDNC advertises, and what a searching SDNC has found, can be kept and verified at a later time for audit and similar purposes. The distributed ledger, referred to herein as an SDN digital ledger or SDL, is based on common, shared Distributed Ledger Technology (DLT) or Blockchain and is used in a “circle of trust” established between SDNCs in order to dynamically create and destroy connections between SDNCs within the circle of trust.

The second requirement, of creating virtual networks, or network slices, in demand, is addressed by an SDNC using virtual network function (VNF) technology to instantiate virtual network elements, and then configuring the VNFs for the end-to-end service, or by configuring existing network elements to provide a network “slice”, or some combination of these techniques that meets the requirements of the requested service for the end-to-end network.

The third requirement is to facilitate SDNC interaction, which is typically via message passing, or via direct API (application programing interface) calls. The APIs and messages for such interactions are well-defined in architectural models such as the Metro Ethernet Forum (MEF) Lifecycle Service Orchestration (LSO), which is a set of technology standards and products that provide orchestration and management integration among network systems, management software and telecommunications IT software platforms. An implication of such architecture, however, is that each of these SDNCs must first know of one another and, secondly, trust one another.

One SDNC cannot accept a message or API call from another SDNC unless it has a trust relationship with that SDNC. A given SDNC cannot make a direct API call, or send a direct message, to another SDNC unless it knows that SDNC exists.

The techniques discussed herein address this challenge by controlling access to the SDN distributed ledger within which the SDNCs advertise themselves, via an automated mechanism, using “Smart Contracts” (code that runs on the distributed ledger and is immutable and transparent to all parties), that ensures that a given SDNC meets objective, automated and testable trust criteria before being able to advertise in the distributed ledger. Thus, the presence of an SDNC advertised in the distributed ledger explicitly means that the SDNC has met the trust criteria, and so may be explicitly trusted by other SDNCs that have also been subject to the same, objective and automated, trust criteria.

This objective, automated and testable trust criteria, enabled by Smart Contracts, forms the basis of the circle of trust supported by the SDN distributed ledger.

The fourth requirement, of recording interactions, i.e. sending a message or making an API call from one SDNC to another, is addressed through the use of the SDN distributed ledger. Specifically, a sending/requesting SDNC records a request in the SDN distributed ledger before it is made, and a receiving SDNC checks that the record of the request is in the SDN distributed ledger before it acts on the request. Likewise, the action on the request is recorded in the SDN distributed ledger so that the requesting SDNC can examine the SDN distributed ledger when a message or API response is received from the SDNC that actioned the request. Note that, importantly, this allows for request-response patterns where multiple SDNCs might respond to a message sent on a message bus, as well as direct interactions between SDNCs using API calls.

The fifth requirement of facilitating interactions for the exchange of financial value is addressed by using the records of the interactions in the SDN distributed ledger as the basis for the automated exchange of value between the business entities that are identified as owning or operating the respective interacting SDNCs. Such exchanges of value between business entities are also recorded in the SDN distributed ledger, and associated with the request response entries that represent the services requested or provided.

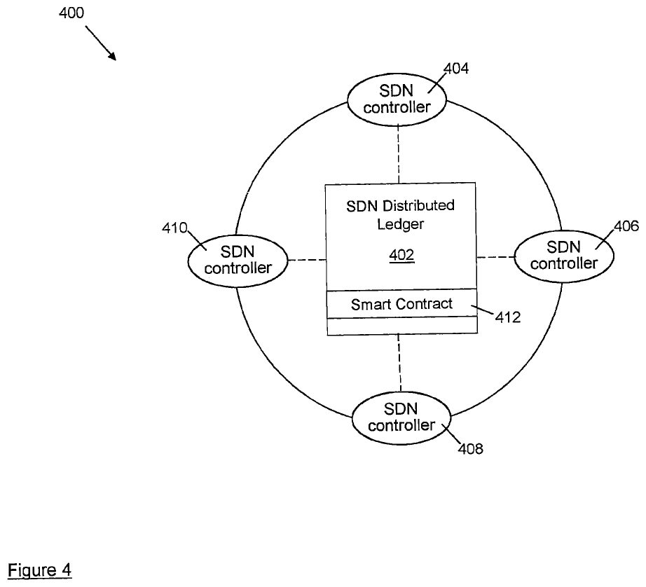

FIG. 4 is a schematic representation of a circle of trust supported by an SDN distributed ledger as used in the techniques described herein.

A circle of trust (CoT), illustrated generally at 400 in FIG. 4, includes a SDN distributed ledger (SDL) 402 and plurality (in this example 4) of SDN controllers (SDNCs) 404, 406, 408, 410 which communicate with the SDN distributed ledger 402 and with each other.

The circle of trust 400 is established between all parties that join the SDN distributed ledger 402. The circle of trust 400 is both a legal entity, established by Smart Contract, and an emergent property of the system. As a consequence of the CoT 400, an SDNC can dynamically establish which other SDNCs exist, and what the properties of the networks that such SDNCs can, or, do control are, and “know” that any such SDNC can be trusted and safely interacted with. For the purposes of implementing this trust relationship, the CoT 400 is a root authority for a certificate issuing mechanism provided by the SDL 402, which issues certificates for SDNCs, such that one SDNC will trust another SDNC identified by a certificate issued by the SDL 402, in the context of the CoT 400.

The SDN distributed ledger 402 also hosts one or more Smart Contracts 412. As described above, a Smart Contract 412 is code that runs on the SDN distributed ledger 402 and is immutable and transparent to all parties. The Smart Contract 412 manages interactions within the circle of trust 400 including (but not limited to):
1) When an SDNC applies to join the circle of trust 400, assuring the validity of a business entity (BE) that owns the SDNC, including validity of bank accounts, legal status, past financial history, physical location and other information about the BE that may be accessed automatically.
2) When an SDNC advertises properties about the networks that it does or can control, verifying that such networks do exist, or can be made to exist on demand, and that the networks have the advertised properties.
3) When a service is provisioned across networks, ensuring that the properties of the service are maintained as defined by the service level agreement, including, but not limited to, quality of service (QoS), location, bandwidth, latency, jitter, temporal availability and other properties of the service that may be measured automatically.
4) Exchanges of value between BEs after the establishment, use, or tear down of a service, or periodically, or upon other conditions that can be automatically determined.
5) The ongoing establishment of the “reputation” of a BE, as the SDNCs that the BE owns engage in interactions with other SDNCs within the SDL over time.
6) Restrictions on the operations of SDNCs as a consequence of information, including reputation, gathered during other aspects of Smart Contract execution, where such restrictions could include, but are not limited to, the removal of SDNCs from the SDL where such SDNCs, or the owning or operating BE, do not meet automatically definable and measureable criteria.

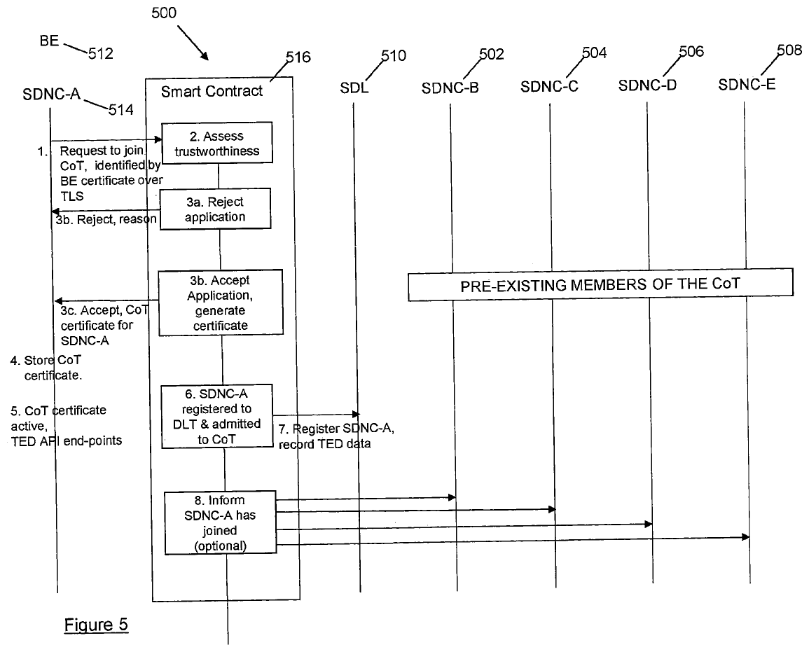

Exemplary processes for registering a new SDNC into a circle of trust, re-admitting a previously registered SDNC into a circle of trust, and establishing service in a circle of trust will now be described with reference to FIGS. 5 to 7 of the accompanying drawings.

Referring first to FIG. 5, a process for registering a new SDNC into a circle of trust for a network is shown generally at 500, in which the new SDNC belongs to a business entity that does not have any SDNCs already participating in the circle of trust.

In this example, a first SDNC 502, a second SDNC 504, a third SDNC 506 and a fourth SDNC 508 are all pre-existing members of a circle of trust of the kind described above supported by an SDN distributed ledger 510. A business entity (BE) 512 wishes for its SDNC 514 to join the circle of trust in order to interact with the other members of the circle of trust (first to fourth SDNCs 502-508) to deliver services. It should be noted that the actual number of SDNCs in the circle of trust can change dynamically, so there is no guarantee that any given SDNC will be in the circle of trust at any given time. If an SDNC leaves the circle of trust, or if the smart contract determines that an SDNC is no longer available (for example because the business entity that owns it does not meet predefined reputation criteria, as discussed in more detail below), the SDN distributed ledger is updated to reflect the status of the SDNC.

The BE 512 instantiates its SDNC 514 (through processes managed by the BE 512 that are outside the scope of this disclosure). The SDNC 514 is configured with a certificate (obtained by the BE 512 through means outside the scope of this disclosure) identifying the BE 512 and populated with information required to join the CoT, including, but not limited to, bank account details, legal address and so on.

In a first step of the process, the SDNC 514 wishing to join the circle of trust sends a request to join the circle of trust, which is received and handled by a Smart Contract 516 associated with the SDL 510. The BE 512 owning or operating the SDNC 514 is identified by the Smart Contract 516 using the data in the certificate that the SDNC 514 provides when it establishes a secure connection with the SDL 510, using, for example, the Transport Layer Security (TLS) protocol.

The Smart Contract 516 performs checks to validate the data within the certificate, provided by the SDNC 514, to establish automatically that the BE 512 that owns the SDNC 514 is a legal operating entity and can exchange value with other BEs that operate other SDNCs participating in the SDL 510 (i.e. that the BE 512 will pay its bills when due). The Smart Contract 516 may also perform other “due diligence” type automated checks, as supported by any data included in the certificate provided by the SDNC 514.

In the case that the Smart Contract 516 is not able automatically to establish correctly the identity of the BE 512, or otherwise validate other associated data, the Smart Contract 516 does not admit the SDNC 514 to the SDL 510 and so the SDNC 514 is unable to join the CoT.

If the Smart Contract 516 is able to validate the data associated with the BE 512, and such data meets the constraints defined by the Smart Contract 516, then the Smart Contract 516 responds to the SDNC 514 with a unique certificate (CoT Cert) for the SDNC 514. Optionally, based on a policy defined by the Smart Contract 516, that certificate may be associated with the IP address of the SDNC 514 to further enhance the security of the relationship between the SDNC 514 and the SDL 510, thus enhancing the CoT.

The SDNC 514 subsequently stores the CoT certificate and informs the Smart Contract 516 that the CoT certificate is active and provides the means (e.g. API end-points) to access one or more Traffic Engineering Databases (TEDs), representing the networks that the SDNC 514 is managing, or can instantiate and manage. A TED is defined as a database that can satisfy the definition in the official Internet Protocol standard RFC6285, and may contain additional data as required for the purposes of fully describing networks for the purposes of service provisioning, and monitoring of the service and the network resources that implement the service. The TED maintains an updated table of all the traffic links that the SDNC 514 can offer, including but not limited to: Ingress; Egress; quality of service (QoS) capabilities; control protocol (e.g. path computation element protocol (PCEP)); API control (e.g. Open Networking Foundation Transport API (ONF T-API)); service level agreements (SLAs); costs; bandwidth; latency; and jitter. The TED contains information representing the nodes, links and other associated information for a network, such that the network nodes can be interacted with for the purposes of service monitoring and verification that the network as recorded in the TED and controlled by SDNC has the capabilities and functionalities advertised.

In the case that SDNC 514 is associated with other CoTs, it can optionally, as defined by the policy in the Smart Contract 516, also be requested to provide the certificates associated with other CoTs. This can be used to support transitive trust relationships between SDNCs in multiple CoTs.

The Smart Contract 516 then accepts the SDNC 514 into the CoT, writes to the SDL 510 that SDNC 514 is a part of the CoT, and records the SDNC 514 TED API end-points and other information (including but not limited to: Ingress; Egress; quality of service (QoS) capabilities; control protocol (e.g. path computation element protocol (PCEP)); API control (e.g. Open Networking Foundation Transport API (ONF T-API)); service level agreements (SLAs); costs; bandwidth; latency; and jitter as well as other information such as: regulatory jurisdiction; physical location of the SDNC hardware server and/or physical network links and/or physical infrastructure controlled by the SDNC, operating constraints, physical locations of ingress and egress points, associated with the networks available from the TED API end-points, and main services offered, e.g. ELINE, EVPN, MPLS/VPN with encapsulation types supported and so on, as part of the record.

The Smart Contract 516 can also query the TEDs and record the contents of the TEDs in the SDL 510 at the time of registration, as defined by policy in the Smart Contract 516. Recording the TED at the time of registration is more relevant for TEDs that represent networks that can be established dynamically and/or have constant properties, as opposed to networks that are subject to change over time.

Optionally, as defined by policy in the Smart Contract 516, other SDNCs 502-508 associated with the CoT can be notified that SDNC-A has joined the CoT.

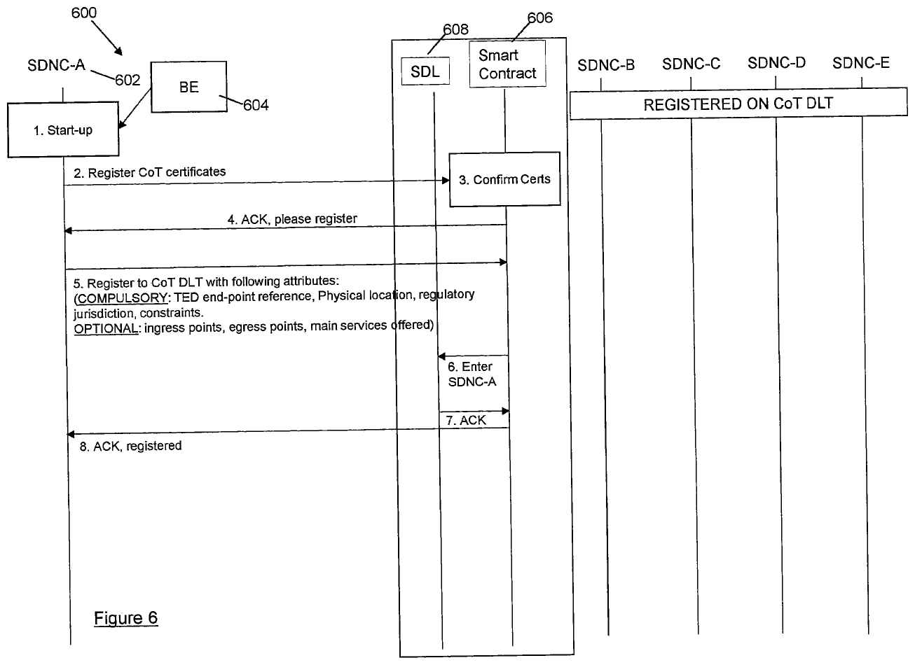

Turning now to FIG. 6, a process for start-up or re-admitting an SDNC into a circle of trust is shown generally at 600. This process is performed once the process of FIG. 5 has been completed, and may be performed either when an SDNC is admitted to the circle of trust for the first time (“start-up), or when an SDNC that has previously left the circle of trust rejoins to the circle of trust (“re-admission”).

An SDNC 602 is started up by its owning or operating BE 604 (using processes that are outside the scope of this disclosure). If the CoT has a policy, by virtue of its Smart Contract 606, that the optional mechanism to associate the certificate of the SDNC 602 with a specific IP address had been employed, then this instance of the SDNC 602 must have the same external IP address as any previous instance to which the certificate had been issued by the Smart Contract 516 in the process of FIG. 5.

The SDNC 602 requesting admission (in the case of an SDNC starting up) or re-admission to the circle of trust sends an admission request including the previously issued CoT certificate to the Smart Contract 606 associated with the SDL 608, in the context of the CoT.

The Smart Contract 606 verifies the CoT certificate for the SDNC 602 (SDNC-A in FIG. 6). This could happen, for example, as a consequence of using TLS and verifying the CoT certificate used to establish the TLS session. Other mechanisms could also be employed to verify that the certificate provided by the SDNC 602 is the same certificate that was provided to the SDNC 602, potentially at the same IP address, when the SDNC 602 joined the CoT previously (as described above with reference to FIG. 5). The Smart Contract 606 can, at this time, also choose to re-verify the BE 604 that owns the SDNC 602 if, for example, a period of time, defined by policy, has passed since the last verification. Such re-verification could result in a new CoT certificate being issued or, indeed, to a circumstance where the BE 604 fails re-verification and so the SDNC 602 is not readmitted to the CoT.

Assuming that the BE 604 has passed any optional re-verification processes, the Smart Contract 606 sends an ACKnowledge response indicating that the SDNC 602 should register its TED, and other, optional, data with the Smart Contract 606, in the context of the CoT.

The SDNC 602 sends a registration to the Smart Contract 606 which includes as COMPULSORY data the TED API end-point reference(s). The optional data mentioned above, which may also be encoded in the BE certificate, could include regulatory jurisdiction, physical location of the SDNC hardware server and/or physical network links and/or physical infrastructure over which the network controlled by the SDNC runs, operating constraints, ingress and egress points, and physical locations thereof, associated with the networks available from the TED API end-points, and main services offered, e.g. ELINE, EVPN, MPLS/VPN with encapsulation types supported and so on.

The Smart Contract 606 registers SDNC 602 with its associated attributes as in the SDL 508. The attributes can later be used by other SDNCs searching for an SDNC that can control a network that could be used as part of an end-to-end service, as described below.

The SDL 608 ACKnowledges entry of the SDNC 602 to the Smart Contract 606 and the Smart Contract 606 ACKnowledges successful re-admission to the entry of the SDNC 602.

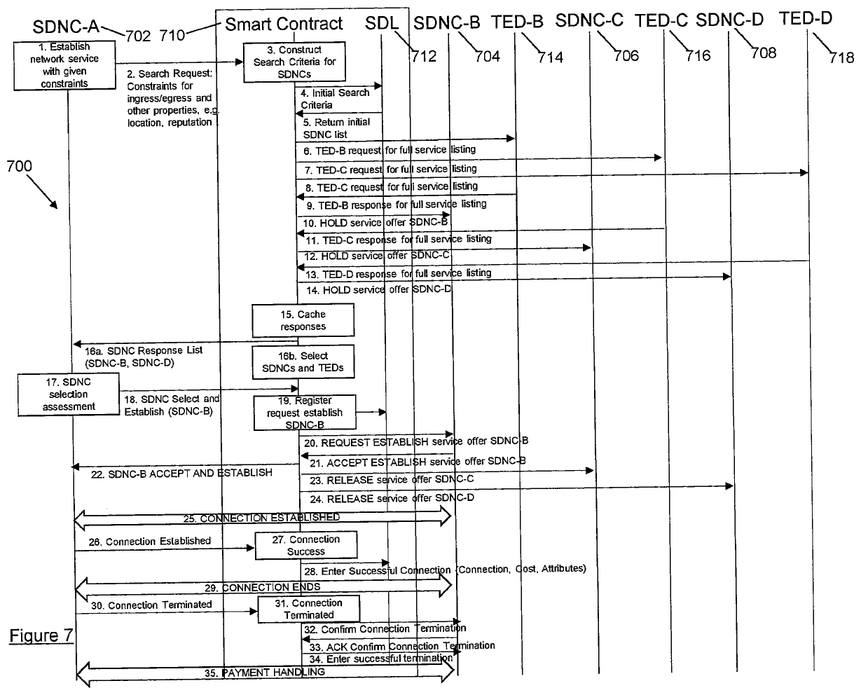

Referring now to FIG. 7, a process for automatically establishing services within a circle of trust is shown generally at 700. In this example, a SDNC 702 wishes to establish services within a pre-existing circle of trust containing first, second and third SDNCs 704, 706, 708 supported by a Smart Contract 710 and an SDN distributed ledger (SDL) 712.

The SDNC 702 is requested to establish a network service, e.g. an Ethernet virtual private network (EVPN), with an ingress point on one of the networks that it controls, with an egress defined by a set of constraints, such as location, network access type, potentially over links with specific constraints, such as bandwidth, jitter, latency QoS and so on. The overall service may also have constraints that, for example, it must be implemented within a specific geographical constraint, or the supplying BE must have a given reputation, and so on. Where the SDNC 702 does not control a network that satisfies the required constraints, it must identify one or more other SDNCs that do control networks that can meet the constraints and interact with those SDNCs to peer or otherwise connect its network with other networks to establish the requested end-to-end service. This must be done dynamically and on-demand.

In a first step of the process 700, the SDNC 702 sends a search request to the Smart Contract 710, in the context of the CoT. This request contains the constraints of the required end-to-end service and so also of potential peer networks that might play a role in that service.

The Smart Contract 710 then creates a search criteria list, based on the request from the SDNC 702. The constraints are composed of those that can be applied to the data that other SDNCs 704, 706, 708 have registered in the SDN distributed ledger (SDL) 712, and data that must be obtained from the TED API end-points provided by the SDNCs 704, 706, 708 when they were registered in the SDL. Importantly, those properties that are registered in the SDL 712 can form part of the audit trail of the overall service establishment process. The data available from the TED API end-points, that are not registered in the SDL 712, can only be evaluated at the point in time when it is queried. In other words, the information in TEDs that can change a lot over should must be queried at the time of creating the search criteria list. The response to the query can be recorded in the SDL 712 for later audit purposes. Different Smart Contracts will apply different policies for different CoTs which will strike a balance between audit requirements, and so data registered in the SDL 712, and implementation and performance constraints implied by registering such data in the SDL 712. Generally, the more immutable a property is, or the lower the volatility of the data that the property represents, the more suitable it is for registration in the SDL 712. Those properties that are dynamic, and so change relatively often, i.e. have high volatility, would, if stored in the SDL 712, necessitate frequent updates such that the overall performance of the system could be negatively impacted.

The Smart Contract 710 sends an initial search request with constraints to the SDL 712 to discover which SDNCs 704, 706, 708 could potentially satisfy the overall service constraints. Searching in the SDL 712 could be done, for example, by applying the constraints of BE reputation, physical location of network and physical infrastructure over which the network controlled by the SDNC runs and other properties that are relatively immutable with respect to the BE and the networks that the SDNC 702 can, or does, control.

The SDL 712 returns an initial list to the Smart Contract, based on the properties of SDNCs 704, 706, 708 registered in the SDL 712. The next steps require that the Smart Contract 710 examines the TEDs for each candidate SDNC 704, 706, 708, via the TED API end-points, to assess whether an existing network managed by one of the SDNCs 704, 706, 708 is able to fulfil the service constraints, or whether a network could be created on demand to satisfy the request. Note that this is an API call from the Smart Contract 710 to each SDNC TED API end-point which is authenticated by certificates, e.g. using TLS, or other API authentication tokens.

The Smart Contract 710 then sends a TED “request for service information” to a TED 714 associated with the SDNC 704. This request for information can contain the constraints previously provided by the SDNC 702, such that the TED 714 can filter its responses based on those constraints. The TED 714 is accessed via the TED API end-point for the TED 714 that was provided by the SDNC 704 when the SDNC 704 registered or was re-admitted previously. The SDNC 704 can, if it determines that its associated TED 174 is able to satisfy the constraints, reserve the resources required for the network services, for a policy defined period, or it can wait for the request from the Smart Contract 710 to do so.

The Smart Contract 710 then sends a TED request for full service information to a TED 716 associated with the SDNC 706.

The Smart Contract 710 then sends a TED request for full service information to a TED 718 associated with the SDNC 708.

The TED 714, after interacting with its associated SDNC 704, sends a response to the Smart Contract 710 indicating whether its associated SDNC 704 is able to fulfil the service constraints set out in the request for service information sent by the Smart Contract 710 to the TED 714. This response can indicate whether the resources by the SDNC 704 have been reserved by the SDNC 704 and for how long.

Alternatively, the Smart Contract 710 can determine whether to request a hold of a service offer from one or more of the SDNCs 704, 706, 708, and request such a hold if necessary.

Thus, the Smart Contract 710 sends a service HOLD request to the SDNC 704, if the SDNC 704 has not already held the service and the Smart Contract 710 has determined that the service should be held.

The TED 716, after interacting with its associated SDNC 706, sends a response to the Smart Contract 710. As with the response sent by the TED 714, this response indicates whether the SDNC 706 associated with the TED 716 is able to fulfil the service constraints set out in the request for service information sent by the Smart Contract 710 to the TED 716, and can indicate whether the resources required to fulfil the service constraints have been reserved by the SDNC 706 and for how long.

The Smart Contract 710 sends a service HOLD request to the SDNC 706, if the SDNC 706 has not already held the service and the Smart Contract 710 has determined that the service should be held.

The TED 718, after interacting with its associated SDNC 708, sends a response to the Smart Contract 710. As with the service response offer sent by the TED 714, this response indicates whether the SDNC 708 associated with the TED 718 is able to fulfil the service constraints set out in the request for service information sent by the Smart Contract 710 to the TED 718, and can indicate whether the resources required to fulfil the service constraints have been reserved by the SDNC 708 and for how long.

The Smart Contract 710 sends a service HOLD request to the SDNC 708, if the SDNC 708 has not already held the service and the Smart Contract 710 has determined that the service should be held.

The Smart Contract 710 can cache the TED API responses for a configurable period, as an implementation performance enhancement feature. As discussed above, how long for, and whether data should be cached or registered in the Smart Contract 710 of SDL is a function of data mutability, volatility and desired system performance.

The Smart Contract 710 can then either send an SDNC response list to the SDNC 702 or make its own determination and select the appropriate SDNCs 704, 706, 708 and TEDs.

In the case where the Smart Contract 710 sends an SDNC response list to the SDNC 702, the SDNC 702 performs internal assessment to select which SDNCs 704, 706, 708 it will interact with to establish the end-to-end service.

In the case where the Smart Contract makes its own determination and selects the appropriate SDNCs 704, 706, 708 and TEDs, the SDNC 702 sends an SDNC select and Establish request, which in this case is for SDNC 704.

In either case, the Smart Contract 710 registers in the SDL 712, for audit and financial transaction purposes, that the SDNC 702 has requested, for example, to interact with SDNC 704 and the networks represented by data in a specific TED, TED-B 714.

The Smart Contract sends an ESTABLISH request to SDNC 704 so that it will instantiate the network service requested. Note that this could cause SDNC 704 to instantiate virtual networks on-demand. There is no sense in which the network required to satisfy the request has to be provisioned or configured until the service request is confirmed. It must be the case that the SDNC 704, in this example, can satisfy the request once it has decided to, or has accepted a request to, reserve the required resources. SDNC 704 can also, before actually provisioning the resources for the service, query the SDL 712 to ensure that the registration of the request is in the SDL 712.

SDNC 704 sends an ACCEPT response to the Smart Contract, indicating that the requested service has been provisioned, and what the service parameters are such that the networks controlled by SDNC 702 can peer or otherwise connect with the network controlled by SDNC 704. This data is also registered in the SDL 712 as part of the audit trail as described above. Note that this audit data may be used for system state recovery purposes if, for example, the SDNC 702 or SDNC 704 fail during these exchanges or at any time subsequently.

The Smart Contract 710 sends the accept and establish response from SDNC 704 to the SDNC 702, including the data required for the SDNC 702 to configure its networks to connect to the ingress of the network controlled by SDNC 704, and to configure other service properties as required.

The Smart Contract 710 RELEASES the hold request to SDNC 706 (or the hold may time out).

The Smart Contract 710 RELEASES the hold request to SDNC 708 (or the hold may time out).

In parallel with above two steps, the networks controlled by the SDNC 702 are peered with the network controlled by SDNC 704, and any required SDNC-SDNC interactions are enabled between the SDNC 702 and SDNC 704, authenticated by virtue of the CoT certificate and/or API authentication tokens as discussed above.

The SDNC 702 sends a connection established confirmation to the Smart Contract 710 and the Smart Contract records the fact that a service provisioning exchange was successful in the SDL 712, with associated attributes. Note that the attributes that are stored may be used for system state recovery if any part of the system fails.

The Smart Contract 710 enters a transaction on the SDL 712 of a successfully provisioned service (Connection, Cost, Attributes and so on). Periodically, the SDNC 702 and/or SDNC 704 may notify the Smart Contract 710 of additional data that can also be registered in the SDL 712 for audit, financial transaction and state recovery purposes. The balance discussed above between data volatility and system performance applies in this case also.

The service may be torn down because of a time-out, a service tear-down request from either the SDNC 702 or SDNC 704, or because of a decision made by the Smart Contract 710 according to policy or for other reasons. Note that the Smart Contract 710 can continually monitor the service by interacting with the SDNC 702, SDNC 704, or with network resources exposed by their respective TEDs 712 and 714. The data gathered during monitoring can be registered in the SDL 712 for the purposes discussed above. The Smart Contract 710 can thus monitor the service to ensure that it is being delivered as per the defined constraints, and can automatically take actions, including termination, changing to a different SDNC and/or network represented by a different TED, as defined by the original constraints and system policies.

If the SDNC 702 decides to end the service, the SDNC 702 sends a service terminated notice to the Smart Contract 710.

The Smart Contract 710 stores the fact that service termination was requested in the SDL 712.

The Smart Contract 710 sends a confirm service termination request to the SDNC 704. The SDNC 704 confirms service is terminated

The Smart Contract 710 enters a transaction into the SDL 712 that the service has been successfully terminated

Payment is handled via the SDN distributed ledger 712 between a business entity that owns the SDNC 702 and a business entity that owns the SDNC 704.

An emergent property of the system and methods described above is a logically single SDNC made up of a plurality of distributed SDNCs, where the state of the SDNC interactions is recorded in the distributed ledger. This creates a resilient system that can survive the failure of the independent SDNCs without loss of the state of provisioned services, or any other information associated with the financial value of the provisioned services.

Another emergent property of system and methods described above is that the record of SDNC interactions recorded in the distributed ledger provides a means to assess the past behaviour of SDNCs and, by extension their owning or operating business entities. This creates a means objectively to establish a reputation for business entities that can be used to allow a given SDNC, owned by one business entity, to make decisions about whether to interact with other SDNCs, owned by other business entities. Also, reputation can be automatically, with a Smart Contract, used to determine whether SDNCs owned by a given business entity should continue to be part of the circle of trust implied by being present in the Distributed Ledger.

The system and methods described above permit the dynamic establishment of trust relationships between SDNCs through the use of the SDN distributed ledger. This in turn reduces the cost of operations and the time to establish services for service providers using SDNCs, as the need for negotiation of individual contracts between individual parties is removed.

Further, the system and methods described above permit higher speed operations for service providers using SDNCs, due to the ability dynamically to establish connections between SDNCs.

In addition, the system and methods described above provide a solution that is significantly more scalable than existing end-to-end networking solutions. The use of the SDN distributed ledger allows SDNCs to connect to and disconnect from the end-to-end network dynamically with no human intervention.

1. A system for providing an end-to-end network comprising a plurality of software defined networks (SDNs), wherein each of the plurality of software defined networks is controlled by a software defined network controller (SDNC), the system comprising:
a distributed ledger, wherein the distributed ledger is associated with a Smart Contract, wherein the Smart Contract comprises software code configured to control access by SDNCs to the distributed ledger by assessing whether a business entity (BE) and an SDNC operated by the business entity, requesting access to the distributed ledger, meet predefined trust criteria.

2. A system according to claim 1 wherein the distributed ledger is further configured to permit SDNCs meeting the predefined trust criteria to advertise themselves to other SDNCs meeting the predefined trust criteria.

3. A system according to claim 1 wherein the distributed ledger is searchable by an SDNC seeking access to a network with particular requirements.

4. A system according to claim 2 wherein the distributed ledger is configured to record networks and capabilities advertised by SDNCs participating in the distributed ledger.

5. A system according to claim 3 wherein the distributed ledger is configured to record the results of a search of the distributed ledger performed by an SDNC seeking access to a network with particular requirements.

6. A system according to claim 1 wherein the distributed ledger is configured to record interactions between business entities operating SDNCs, and interactions between SDNCs, participating in the distributed ledger.

7. A system according to claim 6 wherein the smart contract is configured to record, in the distributed ledger, a request from a first SDNC participating in the distributed ledger sending a message to or making a request of a second SDNC participating in the distributed ledger.

8. A system according to claim 7 wherein the second SDNC is configured to check that the request is present in the distributed ledger before it acts on the request.

9. (canceled)

10. A system according to claim 1 wherein the distributed ledger is further configured to provide a certificate issuing mechanism for issuing certificates for SDNCs, wherein a certificate identifying an SDNC indicates that the SDNC can be trusted by other SDNCs participating in the distributed ledger.

11. (canceled)

12. A system according to claim 1 wherein the Smart Contract is configured to verify the existence or properties of networks advertised by an SDNC as being controlled or controllable by that SDNC.

13. A system according to claim 1 wherein the Smart Contract is configured to ensure that properties of an end-to-end service provisioned across a plurality of different networks are maintained in accordance with a service level agreement for the service.

14. A system according to claim 12 wherein the properties include one or more of:
quality of service;
location;
bandwidth;
latency;
jitter; and
temporal availability.

15. (canceled)

16. A system according to claim 1 wherein the Smart Contract is configured to determine a reputation of a BE that operates an SDNC participating in the distributed ledger based on interactions between the SDNC and other SDNCs participating in the distributed ledger over time.

17. A system according to claim 1 wherein the Smart Contract is configured to impose restrictions on the operations of a SDNC participating in the distributed ledger in the event that the SDNC or a BE that operates the SDNC fails to meet predefined criteria.

18. (canceled)

19. A method for providing an end-to-end network comprising a plurality of software defined networks (SDNs), wherein each of the plurality of software defined networks is controlled by a software defined network controller (SDNC), the method comprising:
providing a distributed ledger, wherein the distributed ledger is associated with a Smart Contract, wherein the Smart Contract comprises software code configured to control access by SDNCs to the distributed ledger by assessing whether a business entity (BE) and an SDNC operated by the business entity, requesting access to the distributed ledger, meet predefined trust criteria.

20. A method according to claim 18 wherein the distributed ledger is further configured to permit SDNCs meeting the predefined trust criteria to advertise themselves to other SDNCs meeting the predefined trust criteria.

21. A method according to claim 18 wherein the distributed ledger is searchable by an SDNC seeking access to a network with particular requirements.

22. A method according to claim 19 wherein the distributed ledger records networks and capabilities advertised by SDNCs participating in the distributed ledger.

23. A system according to claim 20 wherein the distributed ledger records the results of a search of the distributed ledger performed by an SDNC seeking access to a network with particular requirements.

24. A method according to claim 18 wherein the distributed ledger records interactions between business entities operating SDNCs, and interactions between SDNCs, participating in the distributed ledger.

25. A method according to claim 23 wherein the smart contract records, in the distributed ledger, a request from a first SDNC participating in the distributed ledger sending a message to or making a request of a second SDNC participating in the distributed ledger.

26. A method according to claim 24 wherein the second SDNC checks that the request is present in the distributed ledger before it acts on the request.

27. (canceled)

28. A method according to claim 18 wherein the distributed ledger is further configured to provide a certificate issuing mechanism for issuing certificates for SDNCs, wherein a certificate identifying an SDNC indicates that the SDNC can be trusted by other SDNCs participating in the distributed ledger.

29. (canceled)

30. A method according to claim 18 wherein the Smart Contract verifies the existence or properties of networks advertised by an SDNC as being controlled or controllable by that SDNC.

31. A method according to claim 18 wherein the Smart Contract is configured to ensure that properties of an end-to-end service provisioned across a plurality of different networks are maintained in accordance with a service level agreement for the service.

32.-36. (canceled)
